(19) United States
(12) Patent Application Publication
(10) Pub. No.: US 2019/0043216 A1
(43) Pub. Date: Feb. 7, 2019

(54) INFORMATION PROCESSING APPARATUS AND ESTIMATING METHOD FOR ESTIMATING LINE-OF-SIGHT DIRECTION OF PERSON, AND LEARNING APPARATUS AND LEARNING METHOD

(71) Applicant: OMRON Corporation, Kyoto-shi (JP)

(72) Inventors: Tomohiro YABUUCHI, Kyoto-shi (JP); Koichi KINOSHITA, Kyoto-shi (JP); Yukiko YANAGAWA, Kyoto-shi (JP); Tomoyoshi AIZAWA, Kyoto-shi (JP); Tadashi HYUGA, Hirakata-shi (JP); Hatsumi AOI, Kyotanabe-shi (JP); Mei UETANI, Uji-shi (JP)

(73) Assignee: OMRON Corporation, Kyoto-shi (JP)

(21) Appl. No.: 16/015,297

(22) Filed: Jun. 22, 2018

(30) Foreign Application Priority Data
Aug. 1, 2017 (JP) 2017-149344

(51) Int. Cl. G06T 7/73; G06T 7/10; G06T 7/60

(52) U.S. Cl. CPC G06T 7/73; G06T 7/10; G06T 2207/10004; G06T 2207/30201; G06T 2207/20081; G06T 7/60

(57) ABSTRACT

An information processing apparatus for estimating a line-of-sight direction of a person may include: an image acquiring unit configured to acquire an image containing a face of a person; an image extracting unit configured to extract a partial image containing an eye of the person from the image; and an estimating unit configured to input the partial image to a learning device trained through machine learning for estimating a line-of-sight direction, thereby acquiring line-of-sight information indicating a line-of-sight direction of the person from the learning device.

### CROSS-REFERENCES TO RELATED APPLICATIONS

This application claims priority to Japanese Patent Application No. 2017-149344 filed Aug. 1, 2017, the entire contents of which are incorporated herein by reference.

### FIELD

The disclosure relates to an information processing apparatus and an estimating method for estimating a line-of-sight direction of a person in an image, and a learning apparatus and a learning method.

### BACKGROUND

Recently, various control methods using a line of sight of a person, such as stopping a vehicle at a safe location in response to a driver not having his or her eyes on the road, or performing a pointing operation using a line of sight of a user have been proposed, and techniques for estimating a line-of-sight direction of a person have been developed in order to realize such control methods. As one of simple methods for estimating a line-of-sight direction of a person, there is a method that estimates a line-of-sight direction of a person by analyzing an image containing a face of the person.

For example, JP 2007-265367A proposes a line-of-sight detecting method for detecting an orientation of a line of sight of a person in an image. Specifically, according to the line-of-sight detecting method proposed in JP 2007-265367A, a face image is detected from an entire image, a plurality of eye feature points are extracted from an eye of the detected face image, and a plurality of face feature points are extracted from a region constituting a face of the face image. Then, in this line-of-sight detecting method, an eye feature value indicating an orientation of an eye is generated using the extracted plurality of eye feature points, and a face feature value indicating an orientation of a face is generated using the plurality of face feature points, and an orientation of a line of sight is detected using the generated eye feature value and face feature value. It is an object of the line-of-sight detecting method proposed in JP 2007-265367A to efficiently detect a line-of-sight direction of a person by detecting an orientation of a line of sight through simultaneous calculation of a face orientation and an eye orientation, using image processing steps as described above.

JP 2007-265367A is an example of background art.

### SUMMARY

The inventors have found that methods for estimating a line-of-sight direction of a person through this sort of conventional image processing have problems as follows. That is to say, a line-of-sight direction is determined by combining a face orientation and an eye orientation of a person. In the conventional methods, a face orientation and an eye orientation of a person are individually detected using feature values, and thus a face orientation detection error and an eye orientation detection error may occur in a superimposed manner. Accordingly, the inventors have found that the conventional method are problematic in that the level of precision in estimating a line-of-sight direction of a person may possibly be lowered.

One aspect has been made in consideration of such issues and may provide a technique that can improve the level of precision in estimating a line-of-sight direction of a person that appears in an image.

One aspect adopts the following configurations, in order to solve the abovementioned problems.

That is to say, an information processing apparatus according to one aspect is an information processing apparatus for estimating a line-of-sight direction of a person, including: an image acquiring unit configured to acquire an image containing a face of a person; an image extracting unit configured to extract a partial image containing an eye of the person from the image; and an estimating unit configured to input the partial image to a learning device trained through machine learning for estimating a line-of-sight direction, thereby acquiring line-of-sight information indicating a line-of-sight direction of the person from the learning device.

A partial image containing an eye of a person may express a face orientation and an eye orientation of the person. With this configuration, a line-of-sight direction of a person is estimated using the partial image containing an eye of a person, as input to a trained learning device obtained through machine learning. Accordingly, it is possible to directly estimate a line-of-sight direction of a person that may be expressed in a partial image, instead of individually calculating a face orientation and an eye orientation of the person. Accordingly, with this configuration, an estimation error in the face orientation and an estimation error in the eye orientation are prevented from accumulating, and thus it is possible to improve the level of precision in estimating a line-of-sight direction of a person that appears in an image.

Note that “line-of-sight direction” is a direction in which a target person is looking, and is prescribed by combining a face orientation and an eye orientation of the person. Furthermore, “machine learning” is finding a pattern that is behind data (learning data), using a computer, and “learning device” is constructed by a learning model that can attain an ability to identify a predetermined pattern through such machine learning. The type of learning device does not have to be particularly limited as long as an ability to estimate a line-of-sight direction of a person from a partial image can be attained through learning. “Trained learning device” may also be referred to as “identifying device” or “classifying device”.

In the information processing apparatus according to one aspect, it is possible that the image extracting unit extracts, as the partial image, a first partial image containing a right eye of the person and a second partial image containing a left eye of the person, and the estimating unit inputs the first partial image and the second partial image to the trained learning device, thereby acquiring the line-of-sight information from the learning device. With this configuration, respective partial images of both eyes are used as input to a learning device, and thus it is possible to improve the level of precision in estimating a line-of-sight direction of a person that appears in an image.

In the information processing apparatus according to one aspect, it is possible that the learning device is constituted by a neural network, the neural network contains an input layer to which both the first partial image and the second partial image are input, and the estimating unit generates a connected image by connecting the first partial image and the second partial image, and inputs the generated connected image to the input layer. With this configuration, a neural network is used, and thus it is possible to properly and easily construct a trained learning device that can estimate a line-of-sight direction of a person that appears in an image.

In the information processing apparatus according to one aspect, it is possible that the learning device is constituted by a neural network, the neural network contains a first portion, a second portion, and a third portion configured to connect outputs of the first portion and the second portion, the first portion and the second portion are arranged in parallel, and the estimating unit inputs the first partial image to the first portion, and inputs the second partial image to the second portion. With this configuration, a neural network is used, and thus it is possible to properly and easily construct a trained learning device that can estimate a line-of-sight direction of a person that appears in an image. In this case the first portion may be constituted by one or a plurality of convolution layers and pooling layers. The second portion may be constituted by one or a plurality of convolution layers and pooling layers. The third portion may be constituted by one or a plurality of convolution layers and pooling layers.

In the information processing apparatus according to one aspect, it is possible that the image extracting unit detects a face region in which a face of the person appears, in the image, estimates a position of an organ in the face, in the face region, and extracts the partial image from the image based on the estimated position of the organ. With this configuration, it is possible to properly extract a partial image containing an eye of a person, and to improve the level of precision in estimating a line-of-sight direction of a person that appears in an image.

In the information processing apparatus according to one aspect, it is possible that the image extracting unit estimates positions of at least two organs in the face region, and extracts the partial image from the image based on an estimated distance between the two organs With this configuration, it is possible to properly extract a partial image containing an eye of a person based on a distance between two organs, and to improve the level of precision in estimating a line-of-sight direction of a person that appears in an image.

In the information processing apparatus according to one aspect, it is possible that the organs include an outer corner of an eye, an inner corner of the eye, and a nose, the image extracting unit sets a midpoint between the outer corner and the inner corner of the eye, as a center of the partial image, and determines a size of the partial image based on a distance between the inner corner of the eye and the nose. With this configuration, it is possible to properly extract a partial image containing an eye of a person, and to improve the level of precision in estimating a line-of-sight direction of a person that appears in an image.

In the information processing apparatus according to one aspect, it is possible that the organs include outer corners of eyes and an inner corner of an eye, and the image extracting unit sets a midpoint between the outer corner and the inner corner of the eye, as a center of the partial image, and determines a size of the partial image based on a distance between the outer corners of both eyes. With this configuration, it is possible to properly extract a partial image containing an eye of a person, and to improve the level of precision in estimating a line-of-sight direction of a person that appears in an image.

In the information processing apparatus according to one aspect, it is possible that the organs include outer corners and inner corners of eyes, and the image extracting unit sets a midpoint between the outer corner and the inner corner of an eye, as a center of the partial image, and determines a size of the partial image based on a distance between midpoints between the inner corners and the outer corners of both eyes. With this configuration, it is possible to properly extract a partial image containing an eye of a person, and to improve the level of precision in estimating a line-of-sight direction of a person that appears in an image.

The information processing apparatus according to one aspect, it is possible that the apparatus further includes: a resolution converting unit configured to lower a resolution of the partial image, wherein the estimating unit inputs the partial image whose resolution is lowered, to the trained learning device, thereby acquiring the line-of-sight information from the learning device. With this configuration, a partial image whose resolution has been lowered is used as input to a trained learning device, and thus it is possible to reduce the calculation amount of arithmetic processing by the learning device, and to suppress the load on a processor necessary to estimate a line-of-sight direction of a person.

Furthermore, a learning apparatus according to one aspect includes: a learning data acquiring unit configured to acquire, as learning data, a set of a partial image containing an eye of a person and line-of-sight information indicating a line-of-sight direction of the person; and a learning processing unit configured to train a learning device so as to output an output value corresponding to the line-of-sight information in response to input of the partial image. With this configuration, it is possible to construct the trained learning device that is used to estimate a line-of-sight direction of a person.

Note that the information processing apparatus and the learning apparatus according to one or more aspects may also be realized as information processing methods that realize the above-described configurations, as programs, and as recording media in which such programs are recorded and that can be read by a computer or other apparatus or machine. Here, a recording medium that can be read by a computer or the like is a medium that stores information of the programs or the like through electrical, magnetic, optical, mechanical, or chemical effects.

For example, an estimating method according to one aspect is an information processing method that is an estimating method for estimating a line-of-sight direction of a person, causing a computer to execute: image acquiring of acquiring an image containing a face of a person; image extracting of extracting a partial image containing an eye of the person from the image; and estimating of inputting the partial image to a learning device trained through learning for estimating a line-of-sight direction, thereby acquiring line-of-sight information indicating a line-of-sight direction of the person from the learning device.

Furthermore, for example, a learning method according to one aspect is an information processing method for causing a computer to execute: acquiring, as learning data, a set of a partial image containing an eye of a person and line-of-sight information indicating a line-of-sight direction of the person; and training a learning device so as to output an output value corresponding to the line-of-sight information in response to input of the partial image.

According to one or more aspects, it is possible to provide a technique that can improve the level of precision in estimating a line-of-sight direction of a person that appears in an image.

### BRIEF DESCRIPTION OF THE DRAWINGS

FIG. 1 is a diagram schematically illustrating an example of a situation according to an embodiment.

FIG. 2 is a view illustrating a line-of-sight direction.

FIG. 3 is a diagram schematically illustrating an example of the hardware configuration of a line-of-sight direction estimating apparatus according to an embodiment.

FIG. 4 is a diagram schematically illustrating an example of the hardware configuration of a learning apparatus according to an embodiment.

FIG. 5 is a diagram schematically illustrating an example of the software configuration of a line-of-sight direction estimating apparatus according to an embodiment.

FIG. 6 is a diagram schematically illustrating an example of the software configuration of a learning apparatus according to an embodiment.

FIG. 7 is a diagram illustrating an example of the processing procedure of a line-of-sight direction estimating apparatus according to an embodiment.

FIG. 8A is a diagram illustrating an example of a method for extracting a partial image.

FIG. 8B is a diagram illustrating an example of a method for extracting a partial image.

FIG. 8C is a diagram illustrating an example of a method for extracting a partial image.

FIG. 9 is a diagram illustrating an example of the processing procedure of a learning apparatus according to an embodiment.

FIG. 10 is a diagram schematically illustrating an example of the software configuration of a line-of-sight direction estimating apparatus according to a modified example.

FIG. 11 is a diagram schematically illustrating an example of the software configuration of a line-of-sight direction estimating apparatus according to a modified example.

### DETAILED DESCRIPTION

An embodiment according to an aspect (also called “an embodiment” below) will be described next with reference to the drawings. However, an embodiment described below is in all senses merely examples of the present invention. It goes without saying that many improvements and changes can be made without departing from the scope of the present invention. In other words, specific configurations based on an embodiment can be employed as appropriate in carrying out the present invention. Note that although the data mentioned in an embodiment is described with natural language, the data is more specifically defined by quasi-language, commands, parameters, machine language, and so on that can be recognized by computers.

### § 1 Application Example

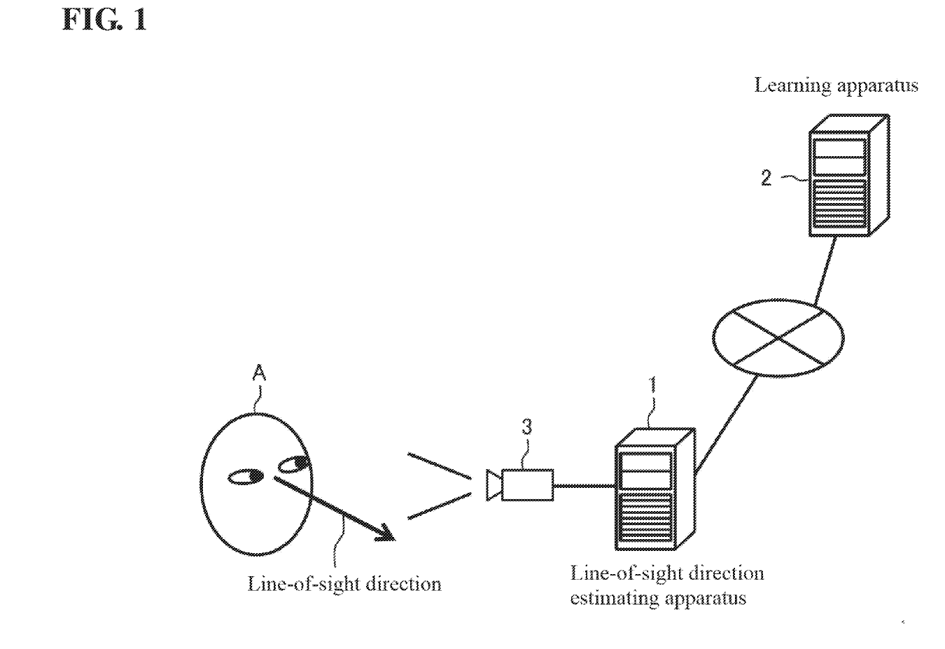

First, an example of a situation according to an embodiment will be described with reference to FIG. 1. FIG. 1 schematically illustrates an example of a situation in which a line-of-sight direction estimating apparatus 1 and a learning apparatus 2 according to an embodiment are applied.

As shown in FIG. 1, the line-of-sight direction estimating apparatus 1 according to an embodiment is an information processing apparatus for estimating a line-of-sight direction of a person A that appears in an image captured by a camera 3. Specifically, the line-of-sight direction estimating apparatus 1 according to an embodiment acquires an image containing a face of the person A from the camera 3. Next, the line-of-sight direction estimating apparatus 1 extracts a partial image containing an eye of the person A, from the image acquired from the camera 3.

This partial image is extracted so as to contain at least one of the right eye and the left eye of the person A. That is to say, one partial image may be extracted so as to contain both eyes of the person A, or may be extracted so as to contain only either one of the right eye and the left eye of the person A.

Furthermore, when extracting a partial image so as to contain only either one of the right eye and the left eye of the person A, only one partial image containing only either one of the right eye and the left eye may be extracted, or two partial images including a first partial image containing the right eye and a second partial image containing the left eye may be extracted. In an embodiment, the line-of-sight direction estimating apparatus 1 extracts two partial images (a first partial image 1231 and a second partial image 1232, which will be described later) respectively containing the right eye and the left eye of the person A.

Then, the line-of-sight direction estimating apparatus 1 inputs the extracted partial image to a learning device (a convolutional neural network 5, which will be described later) trained through learning for estimating a line-of-sight direction, thereby acquiring line-of-sight information indicating a line-of-sight direction of the person A from the learning device. Accordingly, the line-of-sight direction estimating apparatus 1 estimates a line-of-sight direction of the person A.

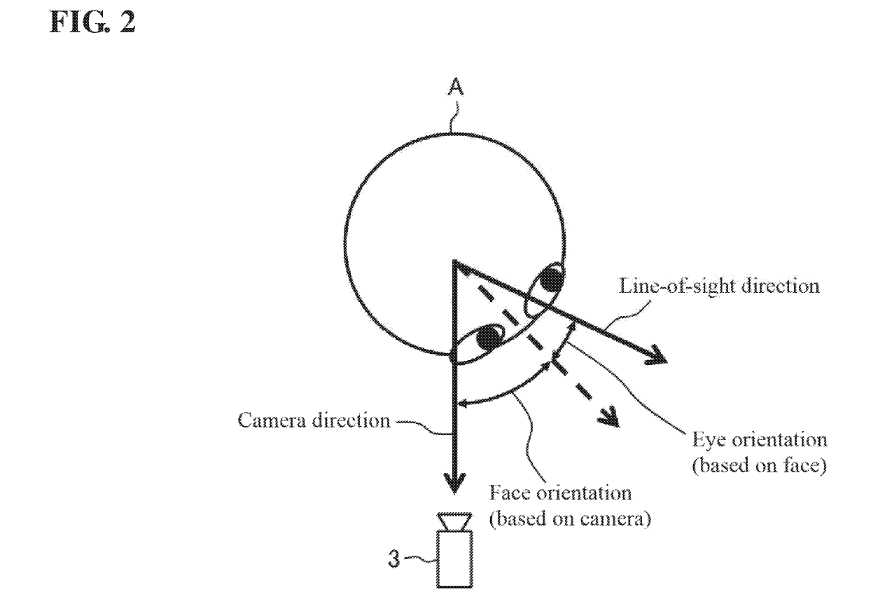

Hereinafter, a “line-of-sight direction” of a person targeted for estimation will be described with reference to FIG. 2. FIG. 2 is a view illustrating a line-of-sight direction of the person A. The line-of-sight direction is a direction in which a person is looking. As shown in FIG. 2, the face orientation of the person A is prescribed based on the direction of the camera 3 (“camera direction” in the drawing). Furthermore, the eye orientation is prescribed based on the face orientation of the person A. Thus, the line-of-sight direction of the person A based on the camera 3 is prescribed by combining the face orientation of the person A based on the camera direction and the eye orientation based on the face orientation. The line-of-sight direction estimating apparatus 1 according to an embodiment estimates such a line-of-sight direction using the above-described method.

Meanwhile, the learning apparatus 2 according to an embodiment is a computer configured to construct a learning device that is used by the line-of-sight direction estimating apparatus 1, that is, configured to cause a learning device to perform machine learning so as to output line-of-sight information indicating a line-of-sight direction of the person A in response to input of a partial image containing an eye of the person A. Specifically, the learning apparatus 2 acquires a set of the partial image and line-of-sight information as learning data. Of these pieces of information, the learning apparatus 2 uses the partial image of as input data, and further uses the line-of-sight information as training data (target data). That is to say, the learning apparatus 2 causes a learning device (a convolutional neural network 6, which will be described later) to perform learning so as to output an output value corresponding to line-of-sight information in response to input of a partial image.

Accordingly, a trained learning device that is used by the line-of-sight direction estimating apparatus 1 can be generated. The line-of-sight direction estimating apparatus 1 can acquire a trained learning device generated by the learning apparatus 2, for example, over a network. The type of the network may be selected as appropriate from among the Internet, a wireless communication network, a mobile communication network, a telephone network, a dedicated network, and the like, for example.

As described above, in an embodiment, a partial image containing an eye of the person A is used as input to a trained learning device obtained through machine learning, so that a line-of-sight direction of the person A is estimated. Since a partial image containing an eye of the person A can express a face orientation based on the camera direction and an eye orientation based on the face orientation, according to an embodiment, a line-of-sight direction of the person A can be properly estimated.

Furthermore, in an embodiment, it is possible to directly estimate a line-of-sight direction of the person A that appears in a partial image, instead of individually calculating the face orientation and the eye orientation of the person A. Thus, according to an embodiment, an estimation error in the face orientation and an estimation error in the eye orientation are prevented from accumulating, and thus it is possible to improve the level of precision in estimating a line-of-sight direction of the person A that appears in an image.

Note that the line-of-sight direction estimating apparatus 1 may be used in various situations. For example, the line-of-sight direction estimating apparatus 1 according to an embodiment may be mounted in an automobile, and be used to estimate a line-of-sight direction of a driver and determine whether or not the driver is having his or her eyes on the road based on the estimated line-of-sight direction. Furthermore, for example, the line-of-sight direction estimating apparatus 1 according to an embodiment may be used to estimate a line-of-sight direction of a user, and perform a pointing operation based on the estimated line-of-sight direction. Furthermore, for example, the line-of-sight direction estimating apparatus 1 according to an embodiment may be used to estimate a line-of-sight direction of a worker of a plant, and estimate the operation skill level of the worker based on the estimated line-of-sight direction.

### § 2 Configuration Example

### Hardware Configuration

### Line-of-Sight Direction Estimating Apparatus

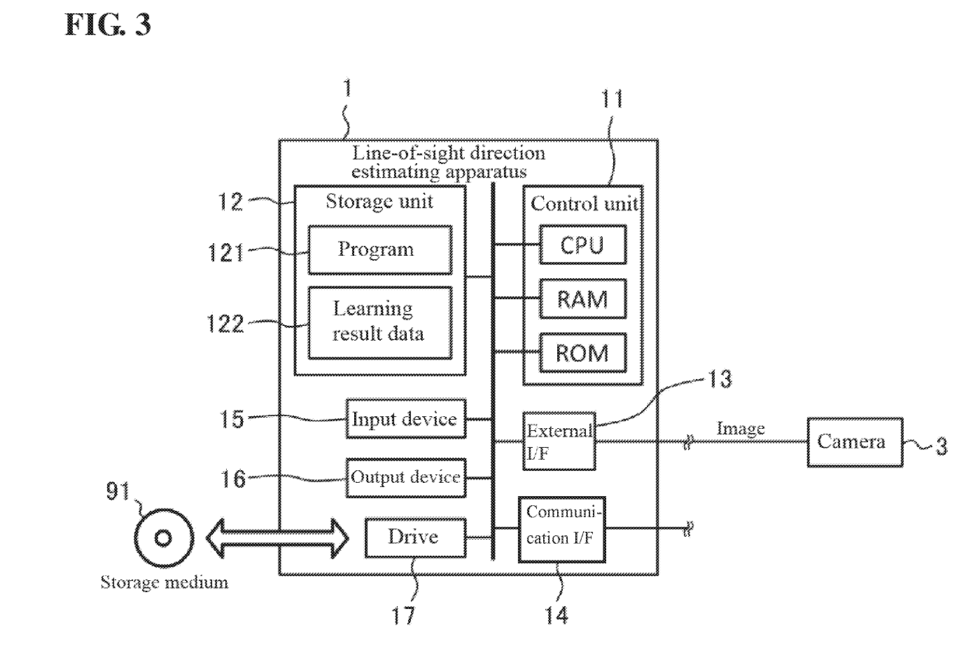

Next, an example of the hardware configuration of the line-of-sight direction estimating apparatus 1 according to an embodiment will be described with reference to FIG. 3. FIG. 3 schematically illustrates an example of the hardware configuration of the line-of-sight direction estimating apparatus 1 according to an embodiment.

As shown in FIG. 3, the line-of-sight direction estimating apparatus 1 according to an embodiment is a computer in which a control unit 11, a storage unit 12, an external interface 13, a communication interface 14, an input device 15, an output device 16, and a drive 17 are electrically connected to each other. In FIG. 3, the external interface and the communication interface are denoted respectively as “external I/F” and “communication I/F”.

The control unit 11 includes a central processing unit (CPU), which is a hardware processor, a random-access memory (RAM), a read-only memory (ROM), and so on, and controls the various constituent elements in accordance with information processing. The storage unit 12 is an auxiliary storage device such as a hard disk drive or a solid-state drive, and stores a program 121, a learning result data 122, and the like. The storage unit 12 is an example of “memory”.

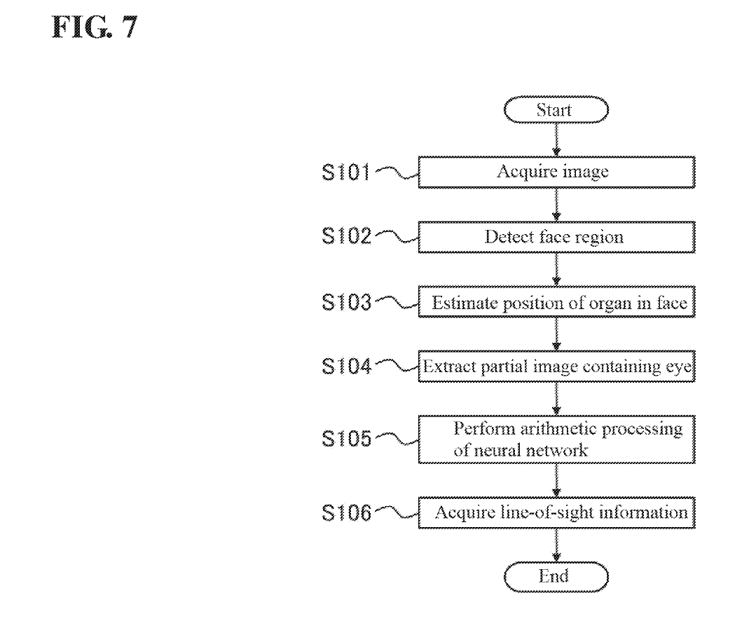

The program 121 contains a command for causing the line-of-sight direction estimating apparatus 1 to execute later-described information processing (FIG. 7) for estimating a line-of-sight direction of the person A. The learning result data 122 is data for setting a trained learning device. Details will be given later.

The external interface 13 is an interface for connecting an external device, and is configured as appropriate in accordance with the external device to be connected. In an embodiment, the external interface 13 is connected to the camera 3.

The camera 3 (image capturing device) is used to capture an image of the person A. The camera 3 may be arranged as appropriate so as to capture an image of at least a face of the person A according to a use situation. For example, in the above-mentioned case of detecting whether or not a driver is having his or her eyes on the road, the camera 3 may be arranged such that the range where the face of the driver is to be positioned during driving is covered as an image capture range. Note that a general-purpose digital camera, video camera, or the like may be used as the camera 3.

The communication interface 14 is, for example, a wired local area network (LAN) module, a wireless LAN module, or the like, and is an interface for carrying out wired or wireless communication over a network. The input device 15 is, for example, a device for making inputs, such as a keyboard, a touch panel, a microphone, or the like. The output device 16 is, for example, a device for output, such as a display screen, a speaker, or the like.

The drive 17 is, for example, a compact disk (CD) drive, a digital versatile disk (DVD) drive, or the like, and is a drive device for loading programs stored in a storage medium 91. The type of the drive 17 may be selected as appropriate in accordance with the type of the storage medium 91. The program 121 and/or the learning result data 122 may be stored in the storage medium 91.

The storage medium 91 is a medium that stores information of programs or the like, through electrical, magnetic, optical, mechanical, or chemical effects so that the recorded information of programs can be read by the computer or other devices or machines. The line-of-sight direction estimating apparatus 1 may acquire the program 121 and/or the learning result data 122 described above from the storage medium 91.

FIG. 3 illustrates an example in which the storage medium 91 is a disk-type storage medium such as a CD or a DVD. However, the type of the storage medium 91 is not limited to a disk, and a type aside from a disk may be used instead. Semiconductor memory such as flash memory can be given as an example of a non-disk type storage medium.

With respect to the specific hardware configuration of the line-of-sight direction estimating apparatus 1, constituent elements can be omitted, replaced, or added as appropriate in accordance with an embodiment. For example, the control unit 11 may include a plurality of hardware processors. The hardware processors may be constituted by microprocessors, field-programmable gate arrays (FPGAs), or the like. The storage unit 12 may be constituted by a RAM and a ROM included in the control unit 11. The line-of-sight direction estimating apparatus 1 may be constituted by a plurality of information processing apparatuses. Furthermore, as the line-of-sight direction estimating apparatus 1, a general-purpose desktop personal computer (PC), a tablet PC, a mobile phone, or the like may be used as well as an information processing apparatus such as a programmable logic controller (PLC) designed specifically for a service to be provided.

### Learning Apparatus

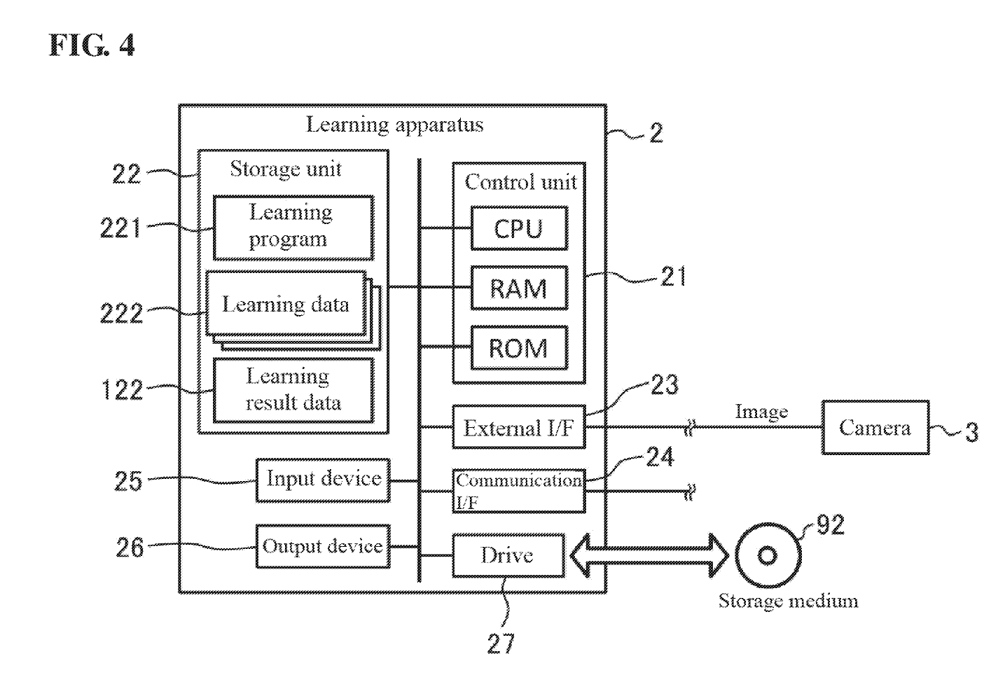

Next, an example of the hardware configuration of the learning apparatus 2 according to an embodiment will be described with reference to FIG. 4. FIG. 4 schematically illustrates an example of the hardware configuration of the learning apparatus 2 according to an embodiment.

As shown in FIG. 4, the learning apparatus 2 according to an embodiment is a computer in which a control unit 21, a storage unit 22, an external interface 23, a communication interface 24, an input device 25, an output device 26, and a drive 27 are electrically connected to each other. In FIG. 4, the external interface and the communication interface are denoted respectively as “external I/F” and “communication I/F” as in FIG. 3.

The constituent elements from the control unit 21 to the drive 27 are respectively similar to those from the control unit 11 to the drive 17 of the line-of-sight direction estimating apparatus 1 described above. Furthermore, a storage medium 92 that is taken into the drive 27 is similar to the storage medium 91 described above. Note that the storage unit 22 of the learning apparatus 2 stores a learning program 221, learning data 222, the learning result data 122, and the like.

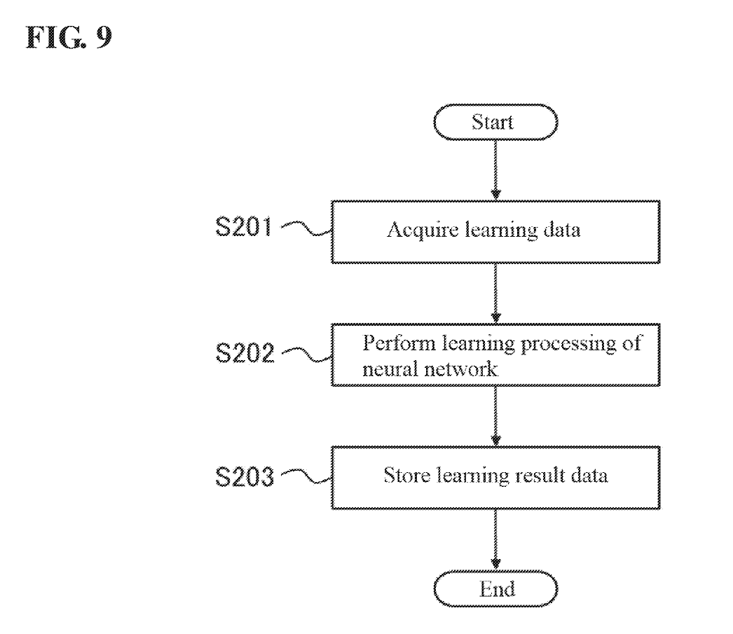

The learning program 221 contains a command for causing the learning apparatus 2 to execute later-described information processing (FIG. 9) regarding machine learning of the learning device. The learning data 222 is data for causing the learning device to perform machine learning such that a line-of-sight direction of a person can be analyzed from a partial image containing an eye of the person. The learning result data 122 is generated as a result of the control unit 21 executing the learning program 221 and the learning device performing machine learning using the learning data 222. Details will be given later.

Note that, as in the line-of-sight direction estimating apparatus 1, the learning program 221 and/or the learning data 222 may be stored in the storage medium 92. Thus, the learning apparatus 2 may acquire the learning program 221 and/or the learning data 222 that is to be used, from the storage medium 92.

With respect to the specific hardware configuration of the learning apparatus 2, constituent elements can be omitted, replaced, or added as appropriate in accordance with an embodiment. Furthermore, as the learning apparatus 2, a general-purpose server apparatus, a desktop PC may be used as well as an information processing apparatus designed specifically for a service to be provided.

### Software Configuration

### Line-of-Sight Direction Estimating Apparatus

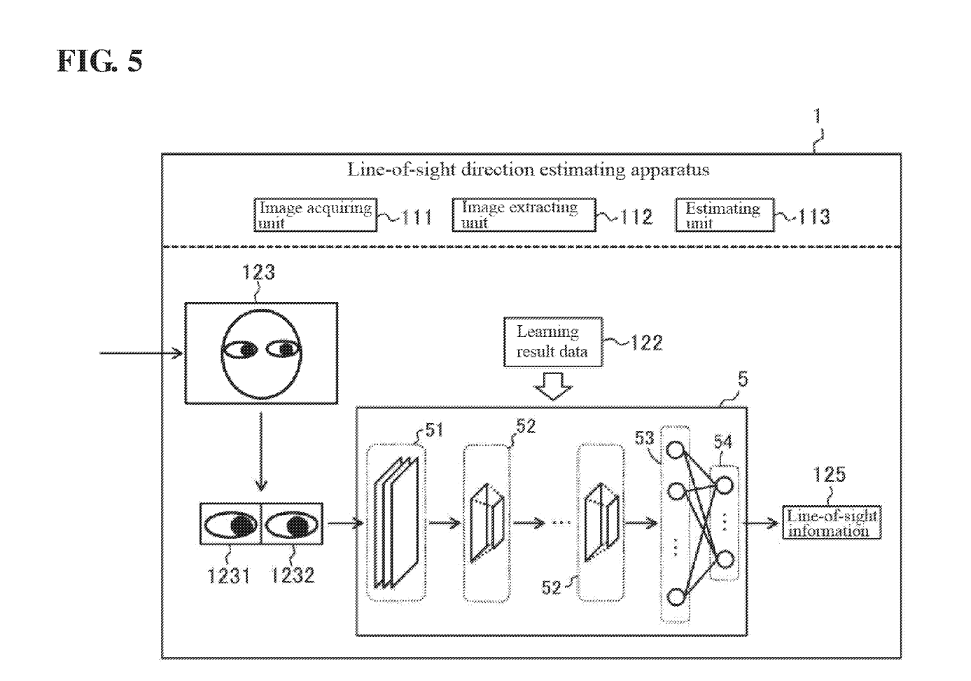

Next, an example of the software configuration of the line-of-sight direction estimating apparatus 1 according to an embodiment will be described with reference to FIG. 5. FIG. 5 schematically illustrates an example of the software configuration of the line-of-sight direction estimating apparatus 1 according to an embodiment.

The control unit 11 of the line-of-sight direction estimating apparatus 1 loads the program 121 stored in the storage unit 12 into the RAM. Then, the control unit 11 controls the various constituent elements by using the CPU to interpret and execute the program 121 loaded into the RAM. Accordingly, as shown in FIG. 5, the line-of-sight direction estimating apparatus 1 according to an embodiment includes, as software modules, an image acquiring unit 111, an image extracting unit 112, and an estimating unit 113.

The image acquiring unit 111 acquires an image 123 containing the face of the person A, from the camera 3. The image extracting unit 112 extracts a partial image containing an eye of the person, from the image 123. The estimating unit 113 inputs the partial image to the learning device (the convolutional neural network 5) trained through machine learning for estimating a line-of-sight direction. Accordingly, the estimating unit 113 acquires line-of-sight information 125 indicating a line-of-sight direction of the person, from the learning device.

In an embodiment, the image extracting unit 112 extracts, as partial images, the first partial image 1231 containing the right eye of the person A and the second partial image 1232 containing the left eye of the person A. The estimating unit 113 inputs the first partial image 1231 and the second partial image 1232 to a trained learning device, thereby acquiring the line-of-sight information 125 from the learning device.

### Learning Device

Next, the learning device will be described. As shown in FIG. 5, in an embodiment, the convolutional neural network 5 is used as the learning device trained through machine learning for estimating a line-of-sight direction of a person.

The convolutional neural network 5 is a feedforward neural network having a structure in which convolution layers 51 and pooling layers 52 are alternately connected. The convolutional neural network 5 according to an embodiment includes a plurality of convolution layers 51 and a plurality of pooling layers 52, and the plurality of convolution layers 51 and the plurality of pooling layers 52 are alternately arranged on the input side. The convolution layer 51 arranged on the most input side is an example of “input layer” of one or more embodiments. The output from the pooling layer 52 arranged on the most output side is input to a fully connected layer 53, and the output from the fully connected layer 53 is input to an output layer 54.

The convolution layers 51 are layers in which image convolution is performed. The image convolution corresponds to processing that calculates a correlation between an image and a predetermined filter. Accordingly, through image convolution, for example, a contrast pattern similar to a contrast pattern of a filter can be detected from an input image.

The pooling layers 52 are layers in which pooling is performed. The pooling partially eliminates information at positions where a response to image filtering is intensive, thereby realizing invariance of responses to slight positional changes in features that appear in images.

The fully connected layer 53 is a layer in which all neurons between adjacent layers are connected. That is to say, each neuron contained in the fully connected layer 53 is connected to all neurons contained in adjacent layers. The fully connected layer 53 may be constituted by two or more layers. The output layer 54 is a layer arranged on the most output side in the convolutional neural network 5.

A threshold value is set for each neuron, and output of each neuron is determined basically based on whether or not the sum of products of each input and each weight exceeds the threshold value. The control unit 11 inputs both the first partial image 1231 and the second partial image 1232 to the convolution layer 51 arranged on the most input side, and determines whether or not each neuron contained in each layer fires, sequentially from the input side. Accordingly, the control unit 11 can acquire an output value corresponding to the line-of-sight information 125, from an output layer 54.

Note that information indicating the configuration of the convolutional neural network 5 (e.g., the number of neurons in each layer, connection between neurons, the transmission function of each neuron), the weight of connection between neurons, and a threshold value for each neuron is contained in the learning result data 122. The control unit 11 sets the trained convolutional neural network 5 that is used in processing for estimating a line-of-sight direction of the person A, referring to the learning result data 122.

### Learning Apparatus

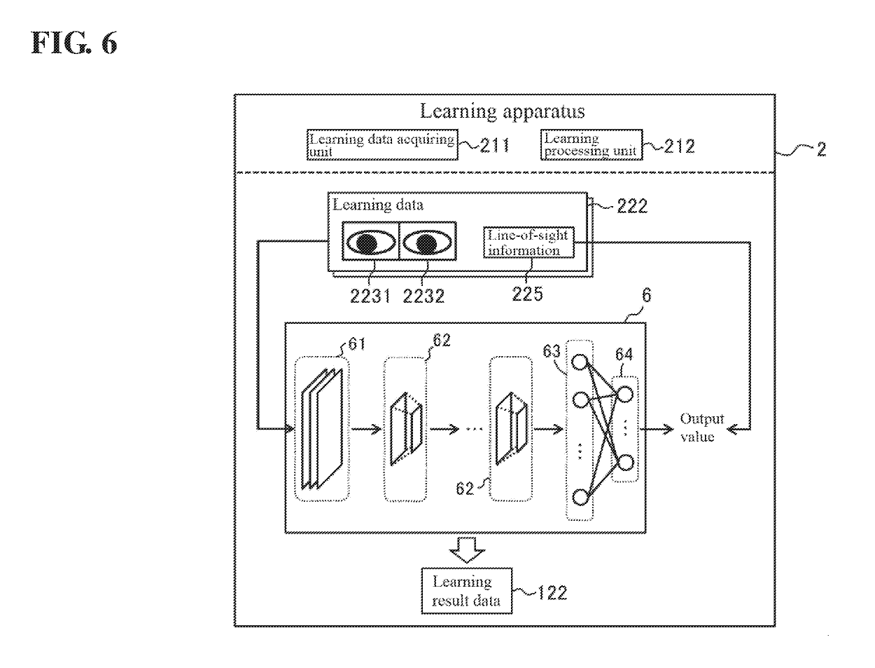

Next, an example of the software configuration of the learning apparatus 2 according to an embodiment will be described with reference to FIG. 6. FIG. 6 schematically illustrates an example of the software configuration of the learning apparatus 2 according to an embodiment.

The control unit 21 of the learning apparatus 2 loads the learning program 221 stored in the storage unit 22 into the RAM. Then, the control unit 21 controls the various constituent elements by using the CPU to interpret and execute the learning program 221 loaded into the RAM. Accordingly, as shown in FIG. 6, the learning apparatus 2 according to an embodiment includes, as software modules, a learning data acquiring unit 211 and a learning processing unit 212.

The learning data acquiring unit 211 acquires, as learning data, a set of a partial image containing an eye of a person and line-of-sight information indicating a line-of-sight direction of the person. As described above, in an embodiment, a first partial image containing the right eye of a person and a second partial image containing the left eye are used as partial images. Accordingly, the learning data acquiring unit 211 acquires, as the learning data 222, a set of a first partial image 2231 containing the right eye of a person, a second partial image 2232 containing the left eye of the person, and line-of-sight information 225 indicating a line-of-sight direction of the person. The first partial image 2231 and the second partial image 2232 respectively correspond to the first partial image 1231 and the second partial image 1232, and are used as input data. The line-of-sight information 225 corresponds to the line-of-sight information 125, and is used as training data (target data). The learning processing unit 212 causes the learning device to perform machine learning so as to output an output value corresponding to the line-of-sight information 225 in response to input of the first partial image 2231 and the second partial image 2232.

As shown in FIG. 6, in an embodiment, the learning device targeted for training is the convolutional neural network 6. The convolutional neural network 6 includes convolution layers 61, pooling layers 62, a fully connected layer 63, and an output layer 64, and is configured as in the convolutional neural network 5. The layers 61 to 64 are similar to the layers 51 to 54 of the convolutional neural network 5 described above.

The learning processing unit 212 constructs the convolutional neural network 6 that outputs an output value corresponding to the line-of-sight information 225 from the output layer 64 in response to input of the first partial image 2231 and the second partial image 2232 to the convolution layer 61 on the most input side, through training of the neural network. Then, the learning processing unit 212 stores information indicating the configuration of the constructed convolutional neural network 6, the weight of connection between neurons, and a threshold value for each neuron, as the learning result data 122, in the storage unit 22.

### Others

Software modules of the line-of-sight direction estimating apparatus 1 and the learning apparatus 2 will be described in detail in Operation Example, which will be described later. In an embodiment, an example will be described in which all of the software modules of the line-of-sight direction estimating apparatus 1 and the learning apparatus 2 are realized by general-purpose CPUs. However, a part or the whole of these software modules may be realized by one or a plurality of dedicated processors. Furthermore, with respect to the respective software configurations of the line-of-sight direction estimating apparatus 1 and the learning apparatus 2, the software modules can be omitted, replaced, or added as appropriate in accordance with an embodiment.

### § 3 Operation Example

### Line-of-Sight Direction Estimating Apparatus

Next, an operation example of the line-of-sight direction estimating apparatus 1 will be described with reference to FIG. 7. FIG. 7 is a flowchart illustrating an example of the processing procedure of the line-of-sight direction estimating apparatus 1. The processing procedure for estimating a line-of-sight direction of the person A, which will be described below, is an example of “estimating method” of one or more embodiments. Note that the processing procedure described below is merely an example, and the processing may be changed to the extent possible. Furthermore, with respect to the processing procedure described below, steps can be omitted, replaced, or added as appropriate in accordance with an embodiment.

### Initial Operation

First, upon starting, the control unit 11 reads the program 121 and performs initial setting processing. Specifically, the control unit 11 sets the structure of the convolutional neural network 5, the weight of connection between neurons, and a threshold value for each neuron, referring to the learning result data 122. Then, the control unit 11 performs processing for estimating a line-of-sight direction of the person A according to the following processing procedure.

### Step S101

In step S101, the control unit 11 operates as the image acquiring unit 111, and acquires an image 123 that may contain the face of the person A from the camera 3. The image 123 that is acquired may be either a moving image or a still image. After acquiring data of the image 123, the control unit 11 advances the processing to the following step S102.

### Step S102

In step S102, the control unit 11 operates as the image extracting unit 112, and detects a face region in which the face of the person A appears, in the image 123 acquired in step S101. For the detection of a face region, a known image analysis method such as pattern matching may be used.

After the detection of a face region is completed, the control unit 11 advances the processing to the following step S103. Note that, if no face of a person appears in the image 123 acquired in step S101, no face region can be detected in this step S102. In this case, the control unit 11 may end the processing according to this operation example, and repeat the processing from step S101.

### Step S103

In step S103, the control unit 11 operates as the image extracting unit 112, and detects organs contained in the face, in the face region detected in step S102, thereby estimating the positions of the organs. For the detection of organs, a known image analysis method such as pattern matching may be used.

The organs that are to be detected are, for example, eyes, a mouth, a nose, or the like. The organs that are to be detected may change depending on the partial image extracting method, which will be described later. After the detection of organs in a face is completed, the control unit 11 advances the processing to the following step S104.

### Step S104

In step S104, the control unit 11 operates as the image extracting unit 112, and extracts a partial image containing an eye of the person A from the image 123. In an embodiment, the control unit 11 extracts, as partial images, the first partial image 1231 containing the right eye of the person A and the second partial image 1232 containing the left eye of the person A. Furthermore, in an embodiment, a face region is detected in the image 123, and the positions of the organs are estimated in the detected face region, steps S102 and S103 described above. Thus, the control unit 11 extracts partial images (1231 and 1232) based on the estimated positions of the organs.

As the methods for extracting the partial images (1231 and 1232) based on the positions of the organs, for example, the following three methods (1) to (3) are conceivable. The control unit 11 may extract the partial images (1231 and 1232) using any one of the following three methods. Note that the methods for extracting the partial images (1231 and 1232) based on the positions of the organs do not have to be limited to the following three methods, and may be determined as appropriate in accordance with an embodiment.

Note that, in the following three methods, the partial images (1231 and 1232) can be extracted through similar processing. Accordingly, in the description below, for the sake of convenience, a situation in which the first partial image 1231 is to be extracted among these partial images will be described, and a description of the method for extracting the second partial image 1232 has been omitted as appropriate because it is similar to that for extracting the first partial image 1231.

### (1) First Method

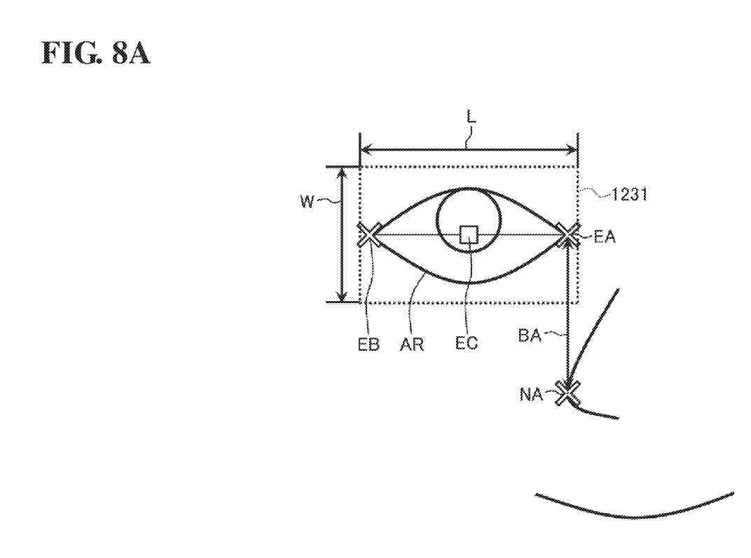

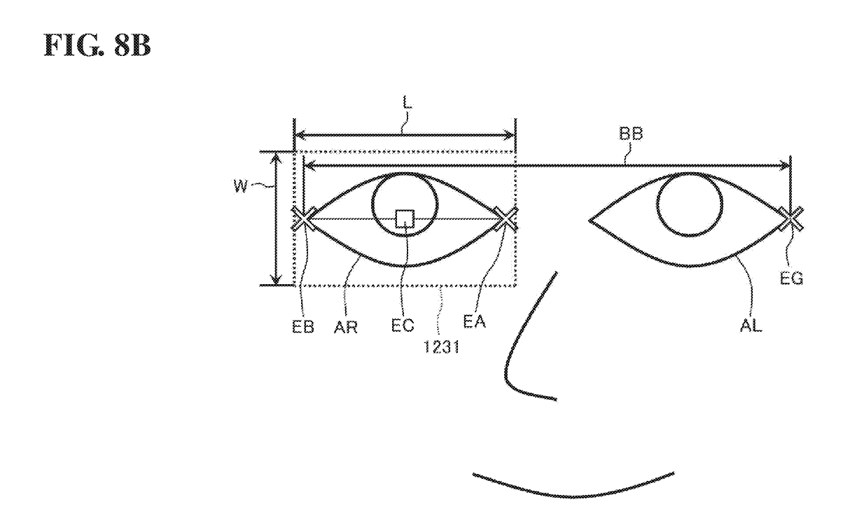

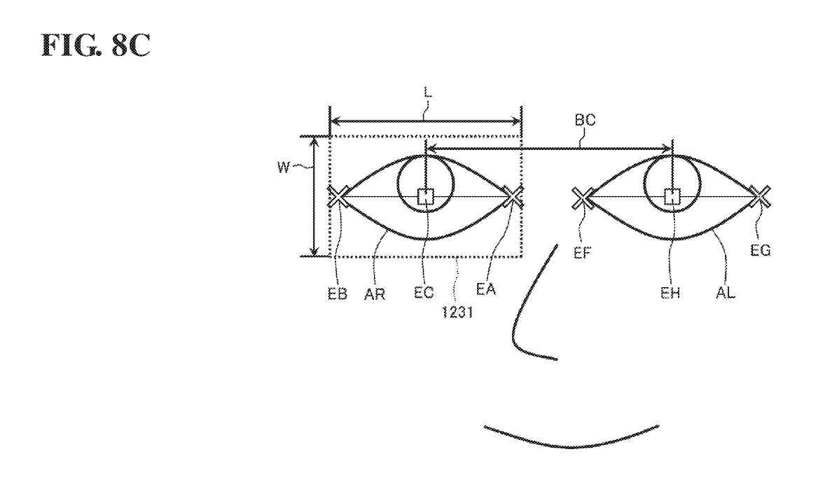

As shown as an example in FIG. 8A, in the first method, the partial images (1231 and 1232) are extracted based on the distance between an eye and a nose. FIG. 8A schematically illustrates an example of a situation in which the first partial image 1231 is to be extracted, using the first method.

In the first method, the control unit 11 sets the midpoint between the outer corner and the inner corner of an eye, as the center of the partial image, and determines the size of the partial image based on the distance between the inner corner of the eye and the nose. Specifically, first, as shown in FIG. 8A, the control unit 11 acquires coordinates of the positions of an outer corner EB and an inner corner EA of the right eye AR, among the positions of the organs estimated in step S103 above. Subsequently, the control unit 11 averages the acquired coordinate values of the outer corner EB and the inner corner EA of the eye, thereby calculating coordinates of the position of a midpoint EC between the outer corner EB and the inner corner EA of the eye. The control unit 11 sets the midpoint EC, as the center of a range that is to be extracted as the first partial image 1231.

Next, the control unit 11 further acquires the coordinate values of the position of a nose NA, and calculates a distance BA between the inner corner EA of the eye and the nose NA based on the acquired coordinate values of the inner corner EA of the right eye AR and the nose NA. In the example in FIG. 8A, the distance BA extends along the vertical direction, but the direction of the distance BA may also be at an angle relative to the vertical direction. Then, the control unit 11 determines a horizontal length L and a vertical length W of the first partial image 1231 based on the calculated distance BA.

At that time, the ratio between the distance BA and at least one of the horizontal length L and the vertical length W may also be determined in advance. Furthermore, the ratio between the horizontal length L and the vertical length W may also be determined in advance. The control unit 11 can determine the horizontal length L and the vertical length W based on each ratio and the distance BA.

For example, the ratio between the distance BA and the horizontal length L may be set to a range of 1:0.7 to 1. Furthermore, for example, the ratio between the horizontal length L and the vertical length W may be set to 1:0.5 to 1. As a specific example, the ratio between the horizontal length L and the vertical length W may be set to 8:5. In this case, the control unit 11 can calculate the horizontal length L based on the set ratio and the calculated distance BA. Then, the control unit 11 can calculate the vertical length W based on the calculated horizontal length L.

Accordingly, the control unit 11 can determine the center and the size of a range that is to be extracted as the first partial image 1231. The control unit 11 can acquire the first partial image 1231 by extracting pixels of the determined range from the image 123. The control unit 11 can acquire the second partial image 1232 by performing similar processing on the left eye.

Note that, in the case of using the first method to extract the partial images (1231 and 1232), in step S103 above, the control unit 11 estimates, as the positions of the organs, the positions of at least the outer corner of an eye, the inner corner of the eye, and the nose. That is to say, the organs whose positions are to be estimated include at least the outer corner of an eye, the inner corner of the eye, and the nose.

### (2) Second Method

As shown as an example in FIG. 8B, in the second method, the partial images (1231 and 1232) are extracted based on the distance between the outer corners of both eyes. FIG. 8B schematically illustrates an example of a situation in which the first partial image 1231 is to be extracted, using the second method.

In the second method, the control unit 11 sets the midpoint between the outer corner and the inner corner of an eye, as the center of the partial image, and determines the size of the partial image based on the distance between the outer corners of both eyes. Specifically, as shown in FIG. 8B, the control unit 11 calculates coordinates of the position of the midpoint EC between the outer corner EB and the inner corner EA of the right eye AR, and sets the midpoint EC, as the center of a range that is to be extracted as the first partial image 1231, as in the above-described first method.

Next, the control unit 11 further acquires the coordinate values of the position of the outer corner EG of the left eye AL, and calculates a distance BB between the outer corners (EB and EG) of both eyes based on the acquired coordinate values of the outer corner EG of the left eye AL and the outer corner EB of the right eye AR. In the example in FIG. 8B, the distance BB extends along the horizontal direction, but the direction of the distance BB may also be at an angle relative to the horizontal direction. Then, the control unit 11 determines the horizontal length L and the vertical length W of the first partial image 1231 based on the calculated distance BB.

At that time, the ratio between the distance BB and at least one of the horizontal length L and the vertical length W may also be determined in advance as in the above-described first method. Furthermore, the ratio between the horizontal length L and the vertical length W may also be determined in advance. For example, the ratio between the distance BB and the horizontal length L may be set to a range of 1:0.4 to 0.5. In this case, the control unit 11 can calculate the horizontal length L based on the set ratio and the calculated distance BB, and can calculate the vertical length W based on the calculated horizontal length L.

Accordingly, the control unit 11 can determine the center and the size of a range that is to be extracted as the first partial image 1231. Then, as in the above-described first method, the control unit 11 can acquire the first partial image 1231 by extracting pixels of the determined range from the image 123. The control unit 11 can acquire the second partial image 1232 by performing similar processing on the left eye.

Note that, in the case of using the second method to extract the partial images (1231 and 1232), in step S103 above, the control unit 11 estimates, as the positions of the organs, the positions of at least the outer corners and the inner corners of both eyes. That is to say, the organs whose positions are to be estimated include at least the outer corners and the inner corners of both eyes. Note that, in the case of omitting extraction of either one of the first partial image 1231 and the second partial image 1232, it is possible to omit estimation of the position of the inner corner of an eye corresponding to the extraction that is omitted.

### (3) Third Method

As shown as an example in FIG. 8C, in the third method, the partial images (1231 and 1232) are extracted based on the distance between midpoints between the inner corners and the outer corners of both eyes. FIG. 8C schematically illustrates an example of a situation in which the first partial image 1231 is to be extracted, using the third method.

In this third method, the control unit 11 sets the midpoint between the outer corner and the inner corner of an eye, as the center of the partial image, and determines the size of the partial image based on the distance between the midpoints between the inner corners and the outer corners of both eyes. Specifically, as shown in FIG. 8C, the control unit 11 calculates coordinates of the position of the midpoint EC between the outer corner EB and the inner corner EA of the right eye AR, and sets the midpoint EC, as the center of a range that is to be extracted as the first partial image 1231, as in the above-described first and second methods.

Next, the control unit 11 further acquires the coordinate values of the positions of the outer corner EG and the inner corner EF of the left eye AL, and calculates coordinates of the position of a midpoint EH between the outer corner EG and the inner corner EF of the left eye AL, as in the case of the midpoint EC. Subsequently, the control unit 11 calculates a distance BC between both midpoints (EC and EH) based on the coordinate values of the midpoints (EC and EH). In the example in FIG. 8C, the distance BC extends along the horizontal direction, but the direction of the distance BC may also be at an angle relative to the horizontal direction. Then, the control unit 11 determines the horizontal length L and the vertical length W of the first partial image 1231 based on the calculated BC.

At that time, the ratio between the distance BC and at least one of the horizontal length L and the vertical length W may also be determined in advance as in the above-described first and second methods. Furthermore, the ratio between the horizontal length L and the vertical length W may also be determined in advance. For example, the ratio between the distance BC and the horizontal length L may be set to a range of 1:0.6 to 0.8. In this case, the control unit 11 can calculate the horizontal length L based on the set ratio and the calculated distance BC, and can calculate the vertical length W based on the calculated horizontal length L.

Accordingly, the control unit 11 can determine the center and the size of a range that is to be extracted as the first partial image 1231. Then, as in the above-described first and second methods, the control unit 11 can acquire the first partial image 1231 by extracting pixels of the determined range from the image 123. The control unit 11 can acquire the second partial image 1232 by performing similar processing on the left eye.

Note that, in the case of using the third method to extract the partial images (1231 and 1232), in step S103 above, the control unit 11 estimates, as the positions of the organs, the positions of at least the outer corners and the inner corners of both eyes. That is to say, the organs whose positions are to be estimated include at least the outer corners and the inner corners of both eyes.

### SUMMARY

According to the three methods described above, the partial images (1231 and 1232) respectively containing both eyes of the person A can be properly extracted. After the extraction the partial images (1231 and 1232) is completed, the control unit 11 advances the processing to the following step S105.

According to the three methods described above, a distance between two organs such as an eye and a nose (the first method), and both eyes (the second method and the third method) is used as a reference for the sizes of the partial images (1231 and 1232). That is to say, in an embodiment, the control unit 11 extracts the partial images (1231 and 1232) based on a distance between two organs. When the sizes of the partial images (1231 and 1232) are determined based on a distance between two organs in this manner, it is sufficient that the control unit 11 estimates the positions of at least two organs in step S103 above. Furthermore, the two organs that can be used as a reference for the sizes of the partial images (1231 and 1232) do not have to be limited to the three examples described above, and organs other than the eyes and the nose may also be used as a reference for the sizes of the partial images (1231 and 1232). For example, in this step S104, a distance between the inner corner of an eye and the mouth may also be used as a reference for the sizes of the partial images (1231 and 1232).

### Steps S105 and S106

In step S105, the control unit 11 operates as the estimating unit 113, and performs arithmetic processing of the convolutional neural network 5 using the extracted first partial image 1231 and the second partial image 1232 as input to the convolutional neural network 5. Accordingly, in step S106, the control unit 11 acquires an output value corresponding to the line-of-sight information 125 from the convolutional neural network 5.

Specifically, the control unit 11 generates a connected image by connecting the first partial image 1231 and the second partial image 1232 extracted in step S104, and inputs the generated connected image to the convolution layer 51 on the most input side of the convolutional neural network 5. For example, a brightness value of each pixel of the connected image is input to a neuron of the input layer of the neural network. Then, the control unit 11 determines whether or not each neuron contained in each layer fires, sequentially from the input side. Accordingly, the control unit 11 acquires an output value corresponding to the line-of-sight information 125 from the output layer 54.

Note that the size of each eye of the person A that appears in the image 123 may change depending on image capture conditions such as the distance between the camera 3 and the person A and the angle in which the person A appears. Accordingly, the sizes of the partial images (1231 and 1232) may change depending on image capture conditions. Thus, the control unit 11 may adjust as appropriate the sizes of the partial images (1231 and 1232) before step S105 such that they can be input to the convolution layer 51 on the most input side of the convolutional neural network 5.

The line-of-sight information 125 obtained from the convolutional neural network 5 indicates an estimation result of a line-of-sight direction of the person A that appears in the image 123. The estimation result is output, for example, in a form of 12.7 degrees to the right. Accordingly, through the above-described processing, the control unit 11 completes the estimation of a line-of-sight direction of the person A, and ends the processing according to this operation example. Note that the control unit 11 may estimate a line-of-sight direction of the person A in real-time by repeating the above-described series of processes. Furthermore, the estimation result of a line-of-sight direction of the person A may be used as appropriate according to a use situation of the line-of-sight direction estimating apparatus 1. For example, as described above, the estimation result of a line-of-sight direction may be used to determine whether or not a driver is having his or her eyes on the road.

### Learning Apparatus

Next, an operation example of the learning apparatus 2 will be described with reference to FIG. 9. FIG. 9 is a flowchart illustrating an example of the processing procedure of the learning apparatus 2. The processing procedure regarding machine learning of a learning device, which will be described below, is an example of “learning method” of one or more embodiments. Note that the processing procedure described below is merely an example, and the processing may be changed to the extent possible. Furthermore, with respect to the processing procedure described below, steps can be omitted, replaced, or added as appropriate in accordance with an embodiment.

### Step S201

In step S201, the control unit 21 of the learning apparatus 2 operates as the learning data acquiring unit 211, and acquires, as the learning data 222, a set of the first partial image 2231, the second partial image 2232, and the line-of-sight information 225.

The learning data 222 is data used for machine learning for enabling the convolutional neural network 6 to estimate a line-of-sight direction of a person that appears in an image. This learning data 222 can be generated by, for example, capturing images of faces of one or a plurality of people under various conditions, and associating the image capture conditions (line-of-sight directions of people) with the first partial image 2231 and the second partial image 2232 extracted from the obtained images.

At that time, the first partial image 2231 and the second partial image 2232 can be obtained by applying processing as in step S104 to the acquired images. Furthermore, the line-of-sight information 225 can be obtained by accepting as appropriate input of angles of line-of-sight directions of people that appear in the captured image.

Note that an image different from the image 123 is used for generation of the learning data 222. A person that appears in this image may be the same as the person A, or may be different from the person A. The image 123 may be used for generation of the learning data 222 after used for estimation of a line-of-sight direction of the person A.

The generation of the learning data 222 may be manually performed by an operator or the like using the input device 25, or may be automatically performed through processing of a program. Furthermore, generation of the learning data 222 may be performed by an information processing apparatus other than the learning apparatus 2. In the case where the learning apparatus 2 generates the learning data 222, the control unit 21 can acquire the learning data 222 by performing generation processing of the learning data 222 in this step S201. Meanwhile, in the case where an information processing apparatus other than the learning apparatus 2 generates the learning data 222, the learning apparatus 2 can acquire the learning data 222 generated by the other information processing apparatus via a network, the storage medium 92, or the like. Note that the number of sets of learning data 222 that are acquired in this step S201 may be determined as appropriate in accordance with an embodiment such that machine learning of the convolutional neural network 6 can be performed.

### Step S202

In the next step S202, the control unit 21 operates as the learning processing unit 212, and performs machine learning of the convolutional neural network 6 so as to output an output value corresponding to the line-of-sight information 225 in response to input of the first partial image 2231 and the second partial image 2232, using the learning data 222 acquired in step S201.

Specifically, first, the control unit 21 prepares the convolutional neural network 6 targeted for learning processing. The configuration of the convolutional neural network 6 that is prepared, an initial value of the weight of connection between neurons, and an initial threshold value for each neuron may be given as templates, or may be given through input from an operator. Furthermore, when performing re-learning, the control unit 21 may prepare the convolutional neural network 6 based on the learning result data 122 targeted for re-learning.

Next, the control unit 21 performs learning processing of the convolutional neural network 6 using the first partial image 2231 and the second partial image 2232 contained in the learning data 222 acquired in step S201, as input data, and using the line-of-sight information 225 as training data (target data). Stochastic gradient descent and the like may be used for the learning processing of the convolutional neural network 6.

For example, the control unit 21 inputs a connected image obtained by connecting the first partial image 2231 and the second partial image 2232, to the convolution layer 61 arranged on the most input side the convolutional neural network 6. Then, the control unit 21 determines whether or not each neuron contained in each layer fires, sequentially from the input side. Accordingly, the control unit 21 obtains an output value from the output layer 64. Next, the control unit 21 calculates error between the output value acquired from the output layer 64 and a value corresponding to the line-of-sight information 225. Subsequently, the control unit 21 calculates errors of weights of connections between neurons and threshold values for neurons, using the error in the calculated output value, through back propagation. Then, the control unit 21 updates the values of weights of connections between neurons and threshold values for neurons, based on the calculated errors.

The control unit 21 repeats the above-described series of processes on each set of learning data until the output value output from the convolutional neural network 6 matches the value corresponding to the line-of-sight information 225. Accordingly, the control unit 21 can construct the convolutional neural network 6 that outputs an output value corresponding to the line-of-sight information 225 in response to input of the first partial image 2231 and the second partial image 2232.

### Step S203

In the next step S203, the control unit 21 operates as the learning processing unit 212, and stores information indicating the configuration of the constructed convolutional neural network 6, the weight of connection between neurons, and a threshold value for each neuron, as the learning result data 122, in the storage unit 22. Accordingly, the control unit 21 ends the learning processing of the convolutional neural network 6 according to this operation example.

Note that, after the processing in step S203 above is completed, the control unit 21 may transfer the generated learning result data 122 to the line-of-sight direction estimating apparatus 1. Furthermore, the control unit 21 may regularly update the learning result data 122 by regularly performing the learning processing in steps S201 to S203 above. Then, the control unit 21 may regularly update the learning result data 122 held by the line-of-sight direction estimating apparatus 1, by transferring the generated learning result data 122 to the line-of-sight direction estimating apparatus 1 at each execution of the learning processing. Furthermore, for example, the control unit 21 may store the generated learning result data 122 in a data server such as a network attached storage (NAS). In this case, the line-of-sight direction estimating apparatus 1 may acquire the learning result data 122 from this data server.

### Actions and Effects

As described above, the line-of-sight direction estimating apparatus 1 according to an embodiment acquires the image 123 in which the face of the person A appears, through the processing in steps S101 to S104 above, and extracts the first partial image 1231 and the second partial image 1232 respectively containing the right eye and the left eye of the person A, from the acquired image 123. Then, the line-of-sight direction estimating apparatus 1 inputs the extracted first partial image 1231 and second partial image 1232 to a trained neural network (the convolutional neural network 5) in steps S105 and S106 above, thereby estimating a line-of-sight direction of the person A. The trained neural network is generated by the learning apparatus 2 using the learning data 222 containing the first partial image 2231, the second partial image 2232, and the line-of-sight information 225.

The first partial image 1231 and the second partial image 1232 respectively containing the right eye and the left eye of the person A express both of a face orientation based on the camera direction and an eye orientation based on the face orientation. Thus, according to an embodiment, a trained neural network and a partial image containing an eye of the person A are used, and thus a line-of-sight direction of the person A can be properly estimated.

Furthermore, in an embodiment, it is possible to directly estimate a line-of-sight direction of the person that appears in the first partial image 1231 and the second partial image 1232 in steps S105 and S106 above, instead of individually calculating the face orientation and the eye orientation of the person A. Thus, according to an embodiment, an estimation error in the face orientation and an estimation error in the eye orientation are prevented from accumulating, and thus it is possible to improve the level of precision in estimating a line-of-sight direction of the person A that appears in an image.

### § 4 Modified Examples

Although an embodiment has been described in detail thus far, the foregoing descriptions are intended to be nothing more than an example of the present invention in all senses. It goes without saying that various improvements and changes can be made without departing from the scope of the present invention. For example, variations such as those described below are also possible. In the following, constituent elements that are the same as those in the above-described embodiment will be given the same reference signs, and points that are the same as in the above-described embodiment will not be described. The following variations can also be combined as appropriate.

4.1

In an embodiment, the line-of-sight direction estimating apparatus 1 directly acquires the image 123 from the camera 3. However, the method for acquiring image 123 does not have to be limited to such an example. For example, the image 123 captured by the camera 3 may be stored in a data server such as a NAS. In this case, the line-of-sight direction estimating apparatus 1 may indirectly acquire the image 123 by accessing the data server in step S101.

4.2

In an embodiment, the line-of-sight direction estimating apparatus 1 detects a face region and organs contained in the face region in steps S102 and S103, and then extracts the partial images (1231 and 1232) using the detection results. However, the method for extracting the partial images (1231 and 1232) does not have to be limited to such an example, and the method may be selected as appropriate in accordance with an embodiment. For example, the control unit 11 may omit steps S102 and S103 above, and detect regions in which eyes of the person A appear in the image 123 acquired in step S101 using a known image analysis method such as pattern matching. Then, the control unit 11 may extract the partial images (1231 and 1232) using the detection result of the regions in which the eyes appear.

Furthermore, in an embodiment, the line-of-sight direction estimating apparatus 1 uses the distance between two organs detected in step S104, as a reference for the sizes of the partial images (1231 and 1232). However, the method for determining the sizes of the partial images (1231 and 1232) using the detected organ does not have to be limited to such an example. The control unit 11 may determine the sizes of the partial images (1231 and 1232) based on the size of one organ, for example, such as an eye, a mouth, or a nose in step S104 above.

Furthermore, in an embodiment, the control unit 11 extracts two partial images including the first partial image 1231 containing the right eye and the second partial image 1232 containing the left eye from the image 123, in step S104, and inputs the extracted two partial images to the convolutional neural network 5. However, the partial images that are extracted from the image 123 do not have to be limited to such an example. For example, the control unit 11 may extract one partial image containing both eyes of the person A from the image 123 in step S104 above. In this case, the control unit 11 may set the midpoint between the outer corners of both eyes, as the center of a range that is to be extracted as a partial image. Furthermore, the control unit 11 may determine the size of a range that is to be extracted as a partial image, based on the distance between two organs as in an embodiment. Furthermore, for example, the control unit 11 extract may one partial image containing only either one of the right eye and the left eye of the person A from the image 123. In each case, the trained neural network is generated using a partial image corresponding to the eyes.

4.3

Furthermore, in an embodiment, the line-of-sight direction estimating apparatus 1 inputs a connected image obtained by connecting the first partial image 1231 and the second partial image 1232, to the convolution layer 51 arranged on the most input side of the convolutional neural network 5, in step S105 above. However, the method for inputting the first partial image 1231 and the second partial image 1232 to the neural network does not have to be limited to such an example. For example, the in the neural network, a portion to which the first partial image 1231 is input and a portion to which the second partial image 1232 is input may be arranged in a separate manner.

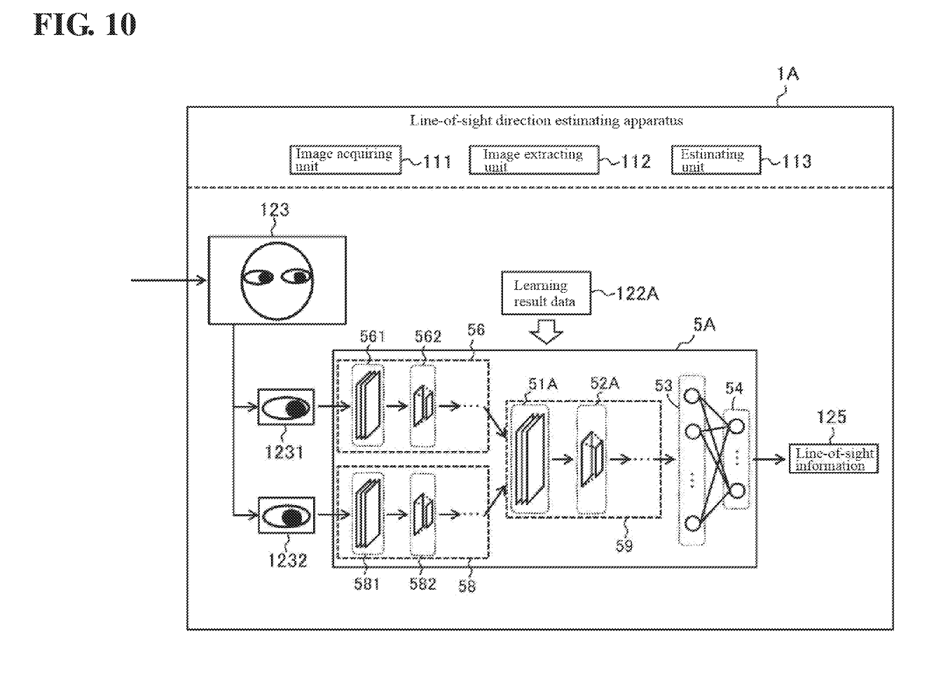

FIG. 10 schematically illustrates an example of the software configuration of a line-of-sight direction estimating apparatus 1A according to this modified example. The line-of-sight direction estimating apparatus 1A is configured as in the above-described line-of-sight direction estimating apparatus 1, except that the configuration of a trained convolutional neural network 5A set by learning result data 122A is different from that in the convolutional neural network 5 described above. As shown as an example in FIG. 10, the convolutional neural network 5A according to this modified example has portions separately configured for the first partial image 1231 and the second partial image 1232 respectively.

Specifically, the convolutional neural network 5A includes a first portion 56 for accepting input of the first partial image 1231, a second portion 58 for accepting input of the second partial image 1232, a third portion 59 for connecting outputs of the first portion 56 and the second portion 58, the fully connected layer 53, and the output layer 54. The first portion 56 is constituted by one or a plurality of convolution layers 561 and pooling layer 562. The number of convolution layers 561 and the number of pooling layer 562 may be determined as appropriate in accordance with an embodiment. In a similar manner, the second portion 58 is constituted by one or a plurality of convolution layers 581 and pooling layers 582. The number of convolution layers 581 and the number of pooling layers 582 may be determined as appropriate in accordance with an embodiment. The third portion 59 is constituted by one or a plurality of convolution layers 51A and pooling layers 52A as in the input portion of an embodiment.

The number of convolution layers 51A and the number of pooling layers 52A may be determined as appropriate in accordance with an embodiment.

In this modified example, the convolution layer 561 on the most input side of the first portion 56 accepts input of the first partial image 1231. The convolution layer 561 on the most input side may also be referred to as a “first input layer”. Furthermore, the convolution layer 581 on the most input side of the second portion 58 accepts input of the second partial image 1232. The convolution layer 581 on the most input side may also be referred to as a “second input layer”. Furthermore, the convolution layer 51A on the most input side of the third portion 59 accepts outputs of the portions (56 and 58). The convolution layer 51A on the most input side may also be referred to as a “connected layer”. Note that, in the third portion 59, the layer arranged on the most input side does not have be limited to the convolution layer 51A, and may also be the pooling layers 52A. In this case, the pooling layer 52A on the most input side is a connected layer for accepting outputs of the portions (56 and 58).

The convolutional neural network 5A can be regarded as being similar to the convolutional neural network 5 although the portions to which the first partial image 1231 and the second partial image 1232 are input are different from that in the convolutional neural network 5. Thus, the line-of-sight direction estimating apparatus 1A according to this modified example can estimate a line-of-sight direction of the person A from the first partial image 1231 and the second partial image 1232 using the convolutional neural network 5A through processing similar to that in the line-of-sight direction estimating apparatus 1.

That is to say, the control unit 11 performs the processing in steps S101 to S104 above as in an embodiment, and extracts the first partial image 1231 and the second partial image 1232. Then, in step S105, the control unit 11 inputs the first partial image 1231 to the first portion 56, and inputs the second partial image 1232 to the second portion 58. For example, the control unit 11 inputs a brightness value of each pixel of the first partial image 1231 to a neuron of the convolution layer 561 arranged on the most input side of the first portion 56. Furthermore, the control unit 11 inputs a brightness value of each pixel of the second partial image 1232 to a neuron of the convolution layer 581 arranged on the most input side of the second portion 58. Then, the control unit 11 determines whether or not each neuron contained in each layer fires, sequentially from the input side. Accordingly, in step S106, the control unit 11 can acquire an output value corresponding to the line-of-sight information 125 from the output layer 54, thereby estimating a line-of-sight direction of the person A.

4.4

Furthermore, in an embodiment, the control unit 11 may adjust the sizes of the first partial image 1231 and the second partial image 1232 before the first partial image 1231 and the second partial image 1232 are input to the convolutional neural network 5 in step S105 above. At that time, the control unit 11 may lower the resolutions of the first partial image 1231 and the second partial image 1232.

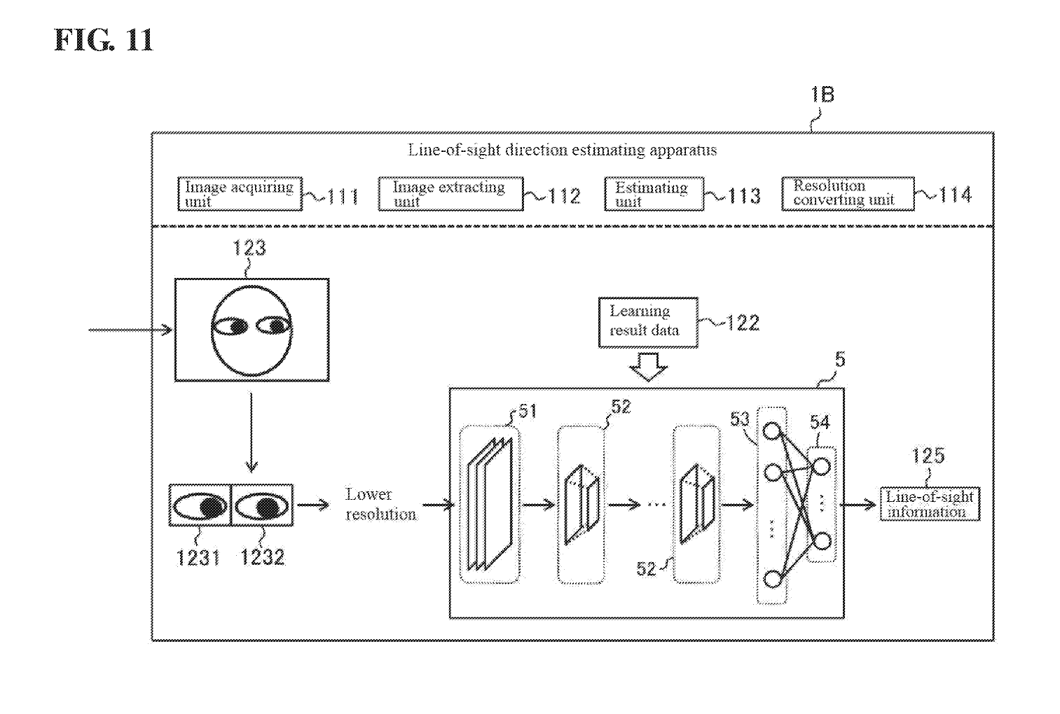

FIG. 11 schematically illustrates an example of the software configuration of a line-of-sight direction estimating apparatus 1B according to this modified example. The line-of-sight direction estimating apparatus 1B is configured as in the above-described line-of-sight direction estimating apparatus 1, except that a resolution converting unit 114 configured to lower the resolution of a partial image is further included as a software module.

In this modified example, before performing the processing in step S105 above, the control unit 11 operates as the resolution converting unit 114, and lower the resolutions of the first partial image 1231 and the second partial image 1232 extracted in step S104. The method for lowering the resolution does not have to be particularly limited, and may be selected as appropriate in accordance with an embodiment. For example, the control unit 11 can lower the resolutions of the first partial image 1231 and the second partial image 1232 through nearest neighbor interpolation, bilinear interpolation, bicubic interpolation, or the like. Then, in steps S105 and S106 above, the control unit 11 inputs the first partial image 1231 and the second partial image 1232 whose resolutions have been lowered, to the convolutional neural network 5, thereby acquiring the line-of-sight information 125 from the convolutional neural network 5. According to this modified example, it is possible to reduce the calculation amount of arithmetic processing by the convolutional neural network 5, and to suppress the load on a CPU necessary to estimate a line-of-sight direction of the person A.

4.5

In an embodiment, a convolutional neural network is used as a neural network for estimating a line-of-sight direction of the person A. However, the type of neural network that can be used to estimate a line-of-sight direction of the person A in an embodiment does not have to be limited to a convolutional neural network, and may be selected as appropriate in accordance with an embodiment. As a neural network for estimating a line-of-sight direction of the person A, for example, an ordinary neural network with a multi-layer structure may be used.

4.6

In an embodiment, a neural network is used as a learning device that is used to estimate a line-of-sight direction of the person A. However, the type of learning device does not have to be limited to a neural network as long as partial images can be used as input, and may be selected as appropriate in accordance with an embodiment. Examples of learning devices that can be used include learning devices that perform machine learning through a support vector machine, a self-organizing map, reinforcement learning, or the like.

4.7

In an embodiment, in step S106 above, the control unit 11 directly acquires the line-of-sight information 125 from the convolutional neural network 5. However, the method for acquiring line-of-sight information from the learning device does not have to be limited to such an example. For example, the line-of-sight direction estimating apparatus 1 may hold reference information in a table format or the like in which an output of a learning device is associated with an angle of a line-of-sight direction, in the storage unit 12. In this case, the control unit 11 may obtain an output value from the convolutional neural network 5 by performing arithmetic processing of the convolutional neural network 5 by using the first partial image 1231 and the second partial image 1232 as input in step S105 above. Then, in step S106 above, the control unit 11 may acquire the line-of-sight information 125 corresponding to an output value obtained from the convolutional neural network 5, by referring to the reference information. In this manner, the control unit 11 may indirectly acquire the line-of-sight information 125.

4.8

Furthermore, in an embodiment, the learning result data 122 contains information indicating the configuration of the convolutional neural network 5. However, the configuration of the learning result data 122 does not have to be limited to such an example. For example, if the configuration of neural networks that are used are commonized, the learning result data 122 may not contain information indicating the configuration of the convolutional neural network 5.

1. An information processing apparatus for estimating a line-of-sight direction of a person, the apparatus comprising:
an image acquiring unit configured to acquire an image containing a face of a person;
an image extracting unit configured to extract a partial image containing an eye of the person from the image; and
an estimating unit configured to input the partial image to a learning device trained through machine learning for estimating a line-of-sight direction, thereby acquiring line-of-sight information indicating a line-of-sight direction of the person from the learning device.

2. The information processing apparatus according to claim 1,
wherein the image extracting unit extracts, as the partial image, a first partial image containing a right eye of the person and a second partial image containing a left eye of the person, and
the estimating unit inputs the first partial image and the second partial image to the trained learning device, thereby acquiring the line-of-sight information from the learning device.

3. The information processing apparatus according to claim 2,
wherein the learning device is constituted by a neural network,
the neural network contains an input layer, and
the estimating unit generates a connected image by connecting the first partial image and the second partial image, and inputs the generated connected image to the input layer.

4. The information processing apparatus according to claim 2,
wherein the learning device is constituted by a neural network,
the neural network contains a first portion, a second portion, and a third portion configured to connect outputs of the first portion and the second portion,
the first portion and the second portion are arranged in parallel, and
the estimating unit inputs the first partial image to the first portion, and inputs the second partial image to the second portion.

5. The information processing apparatus according to claim 4,
wherein the first portion is constituted by one or a plurality of convolution layers and pooling layers,
the second portion is constituted by one or a plurality of convolution layers and pooling layers, and
the third portion is constituted by one or a plurality of convolution layers and pooling layers.

6. The information processing apparatus according to claim 1,
wherein the image extracting unit
detects a face region in which a face of the person appears, in the image,
estimates a position of an organ in the face, in the face region, and
extracts the partial image from the image based on the estimated position of the organ.

7. The information processing apparatus according to claim 6, wherein the image extracting unit estimates positions of at least two organs in the face region, and extracts the partial image from the image based on an estimated distance between the two organs.

8. The information processing apparatus according to claim 7,
wherein the organs include an outer corner of an eye, an inner corner of the eye, and a nose,
the image extracting unit sets a midpoint between the outer corner and the inner corner of the eye, as a center of the partial image, and determines a size of the partial image based on a distance between the inner corner of the eye and the nose.

9. The information processing apparatus according to claim 7,
wherein the organs include outer corners of eyes and an inner corner of an eye, and
the image extracting unit sets a midpoint between the outer corner and the inner corner of the eye, as a center of the partial image, and determines a size of the partial image based on a distance between the outer corners of both eyes.

10. The information processing apparatus according to claim 7,
wherein the organs include outer corners and inner corners of eyes, and
the image extracting unit sets a midpoint between the outer corner and the inner corner of an eye, as a center of the partial image, and determines a size of the partial image based on a distance between midpoints between the inner corners and the outer corners of both eyes.

11. The information processing apparatus according to claim 1, further comprising:
a resolution converting unit configured to lower a resolution of the partial image,
wherein the estimating unit inputs the partial image whose resolution is lowered, to the trained learning device, thereby acquiring the line-of-sight information from the learning device.

12. The information processing apparatus according to claim 2,
wherein the image extracting unit
detects a face region in which a face of the person appears, in the image,
estimates a position of an organ in the face, in the face region, and
extracts the partial image from the image based on the estimated position of the organ.

13. The information processing apparatus according to claim 3,
wherein the image extracting unit
detects a face region in which a face of the person appears, in the image,
estimates a position of an organ in the face, in the face region, and
extracts the partial image from the image based on the estimated position of the organ.

14. The information processing apparatus according to claim 4,
wherein the image extracting unit
detects a face region in which a face of the person appears, in the image,
estimates a position of an organ in the face, in the face region, and
extracts the partial image from the image based on the estimated position of the organ.

15. The information processing apparatus according to claim 5,
wherein the image extracting unit
detects a face region in which a face of the person appears, in the image,
estimates a position of an organ in the face, in the face region, and
extracts the partial image from the image based on the estimated position of the organ.

16. An estimating method for estimating a line-of-sight direction of a person, the method causing a computer to execute:
image acquiring of acquiring an image containing a face of a person;
image extracting of extracting a partial image containing an eye of the person from the image; and
estimating of inputting the partial image to a learning device trained through learning for estimating a line-of-sight direction, thereby acquiring line-of-sight information indicating a line-of-sight direction of the person from the learning device.

17. A learning apparatus comprising:
a learning data acquiring unit configured to acquire, as learning data, a set of a partial image containing an eye of a person and line-of-sight information indicating a line-of-sight direction of the person; and
a learning processing unit configured to train a learning device so as to output an output value corresponding to the line-of-sight information in response to input of the partial image.

18. A learning method for causing a computer to execute:
acquiring, as learning data, a set of a partial image containing an eye of a person and line-of-sight information indicating a line-of-sight direction of the person; and
training a learning device so as to output an output value corresponding to the line-of-sight information in response to input of the partial image.
